(19) United States
(12) Patent Application Publication
(10) Pub. No.: US 2026/0061502 A1
(43) Pub. Date: Mar. 5, 2026

(54) Drill Having Web Relief

(71) Applicant: Kennametal Inc., Latrobe, PA (US)

(72) Inventors: Li Ning, Pleasant Unity, PA (US); Herbert Kauper, Rosstal (DE); Juergen Schwaegerl, Vohenstrauss (DE); Verena Fischer, Burgebrach (DE)

(73) Assignee: Kennametal Inc., Latrobe, PA (US)

(21) Appl. No.: 18/816,075

(22) Filed: Aug. 27, 2024

(51) Int. Cl. B23B 51/08

(52) U.S. Cl. CPC B23B 51/08

(57) ABSTRACT

A drill includes a body having a plurality of flutes extending along the body and a point at a cutting end of the body. The point has a web positioned between the flutes and a chisel edge on the web. The point has a cutting lip and a flank surface defining one of the flutes. The cutting lip extends from the chisel edge and the flank surface extends from a side of the chisel edge opposite the cutting lip. The web has a relief extending into the flank surface.

### FIELD OF THE INVENTION

The present disclosure relates to a cutting tool and, more particularly, to a drill having a relief in the web.

### BACKGROUND

In hole drilling, drills commonly have a centrally positioned web that has a chisel edge at a cutting end. During rotation, cutting lips of the drill chip or remove a material to create the hole. The surfaces of the web also engage the material during rotation, but push the material instead of cutting and restrict evacuation of the chips, which creates high pressure and high friction in a center area of the drill. This high pressure and friction increases wear on the drill, which decreases the durability and useful life of the drill.

In some existing drills, the web is thinned to avoid the aforementioned issues with increased pressure and friction. Exclusively thinning the web to address these issues, however, impairs the centering and stability of the drill, decreasing the cutting precision and performance of the drill.

### SUMMARY

A drill includes a body having a plurality of flutes extending along the body and a point at a cutting end of the body. The point has a web positioned between the flutes and a chisel edge on the web. The point has a cutting lip and a flank surface defining one of the flutes. The cutting lip extends from the chisel edge and the flank surface extends from a side of the chisel edge opposite the cutting lip. The web has a relief extending into the flank surface.

### BRIEF DESCRIPTION OF THE DRAWINGS

The invention will now be described by way of example with reference to the accompanying Figures, of which:

FIG. 1 is a side view of an end section of a drill according to an embodiment;

FIG. 2 is a front view of a cutting end of the drill;

FIG. 3 is a front detail view of a portion D of FIG. 2;

FIG. 4 is a sectional perspective detail view of the portion D of FIG. 2 taken along line 4-4 of FIG. 2; and

FIG. 5 is a front view of a cutting end of a drill according to another embodiment.

### DETAILED DESCRIPTION OF THE EMBODIMENTS

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art. In addition, in the following detailed description, for purposes of explanation, numerous specific details are set forth to provide a thorough understanding of the disclosed embodiments. However, it is apparent that one or more embodiments may also be implemented without these specific details.

Throughout the drawings, only one of a plurality of identical elements may be labeled in a figure for clarity of the drawings, but the detailed description of the element herein applies equally to each of the identically appearing elements in the figure. Throughout the specification, directional descriptors are used such as “rotation axis,” “circumferential direction,” and “radial direction.” These descriptors are merely for clarity of the description and for differentiation of the various directions. These directional descriptors do not imply or require any particular orientation of the disclosed elements.

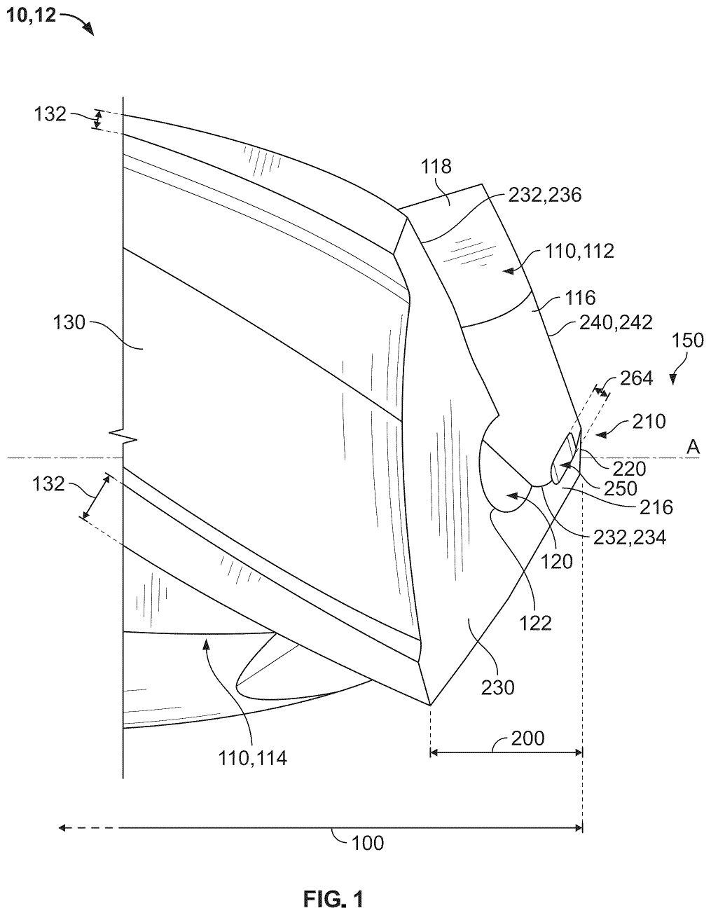

A drill 10 according to an embodiment is shown in FIGS. 1-3. The drill 10 has a body 100 and a point 200 at a cutting end 150 of the body 100. In FIG. 1, only an end section 12 of the drill 10 is shown for clarity of the drawings and corresponding description. It is understood, however, that the body 100 having the elements described below continues along a rotation axis A of the drill 10, from the end section 12, in a direction away from the point 200 to a neck and/or shank of the drill 10.

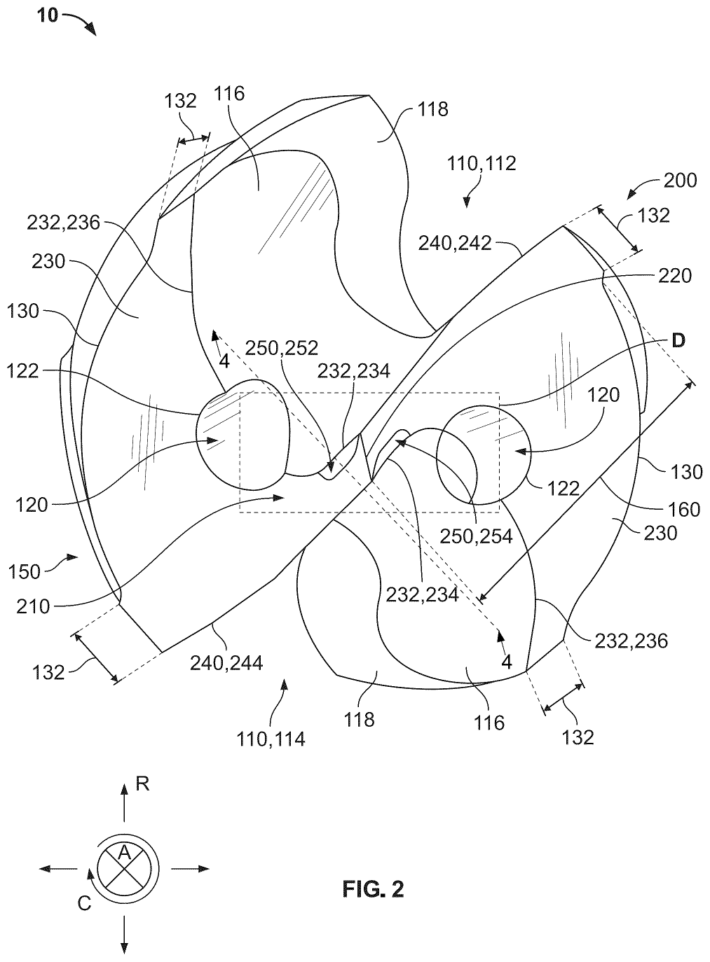

As shown in FIG. 1, the body 100 has a plurality of flutes 110 extending along the body 100 and along a rotation axis A of the drill 10. The flutes 110, in the shown embodiment, include a first flute 112 and a second flute 114 that extend helically along the body 100 around the rotation axis A. Each of the flutes 112, 114, as shown in FIGS. 1 and 2, has a first flute surface 116 that extends from the cutting end 150 and a second flute surface 118 that extends from the first flute surface 116 along the rotation axis A. In the shown embodiment, the first flute surface 116 extends at a greater angle than the second flute surface 118 with respect to the rotation axis A.

The body 100, as shown in FIGS. 1 and 2, has a pair of channels 120 extending through the body 100 helically around the rotation axis A. The channels 120 are spaced apart from one another in a radial direction R of the body 100. Each of the channels 120 terminates at an end opening 122 at the point 200. In the shown embodiment, each of the channels 120 is a circular shaped opening extending through the body 100; in other embodiments, the body 100 may have one or three or more channels 120, which may have circular shapes or other different cross-sectional shapes. In an exemplary embodiment, a cooling fluid can be supplied through the channels 120 during cutting to cool the drill 10.

The body 100 has a pair of lands 130, as shown in FIGS. 1 and 2, on a peripheral portion of the body 100 and extending in a circumferential direction C between the first flute 112 and the second flute 114. Each of the lands 130 may have a margin 132 or a plurality of margins 132 at which the land 130 is thicker or extends further from the rotation axis A.

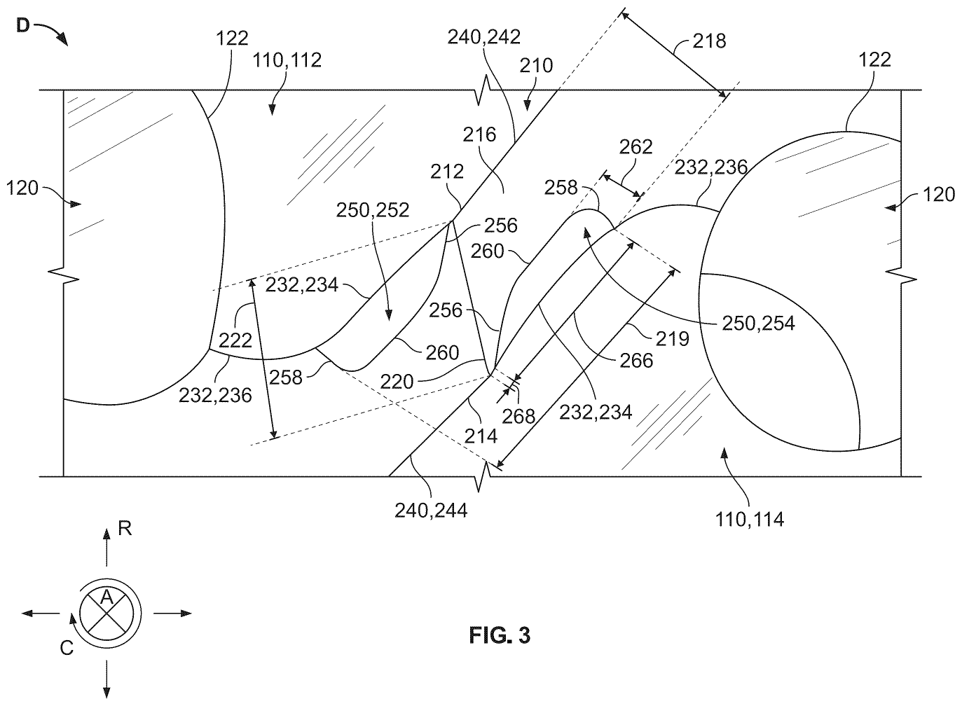

The point 200 at the cutting end 150 of the body 100, as shown in FIGS. 1 and 2, has a web 210 positioned between the flutes 110 and aligned centrally along the rotation axis A. As shown in FIG. 3, the web 210 has a first side surface 212 facing the first flute 112 and a second side surface 214 opposite the first side surface 212 that faces the second flute 114. The web 210 has an upper surface 216 that faces along the rotation axis A and forms a portion of the cutting end 150. The web 210 has a web thickness 218 extending in the radial direction R between the first side surface 212 and the second side surface 214. The web 210 has a web length 219 extending in the radial direction R perpendicular to the web thickness 218. In the shown embodiment, the web length 219 is greater than the web thickness 218.

As shown in FIGS. 1-3, the point 200 has a chisel edge 220 on the web 210. The chisel edge 220 is a leading end of the drill 10 at the cutting end 150 that first makes contact with a material to be cut. The chisel edge 220 is positioned centrally along the rotation axis A and the web 210 is angled to the chisel edge 220 in a direction extending along the rotation axis A, as shown in FIG. 1. The chisel edge 220, as shown in FIG. 3, has a chisel edge length 222 in the radial direction R. In the shown embodiment, the web length 219 is greater than the chisel edge length 222.

The point 200, as shown in FIG. 2, has a pair of flanks 230 that are faces extending between the lands 130 and the web 210. The flanks 230 are faces that are angled with respect to the rotation axis A. Each of the flanks 230 has a flank surface 232 that borders and defines one of the flutes 110. In the shown embodiment, the flank surfaces 232 each have a straight section 234 extending from the chisel edge 220 and a curved section 236 extending from the straight section 234 to one of the lands 130. The web 210 forms the straight section 234 of each of the flank surfaces 232. In another embodiment, the flank surfaces 232 may not have the straight section 234 and the curved section 236 may extend from the chisel edge 220 to one of the lands 130; in this embodiment, the web 210 is formed in the curved section 236 of each of the flank surfaces 232.

As shown in FIG. 2, the channels 120 are spaced apart from the web 210 in the radial direction R. The end opening 122 of each of the channels 120, in the shown embodiment, extends through one of the flanks 230, the curved section 236 of one of the flank surfaces 232, and the first flute surface 116 of one of the flutes 110.

The point 200 has a pair of cutting lips 240, as shown in FIG. 2, that include a first cutting lip 242 and a second cutting lip 244. The cutting lips 240 are the primary edges of the drill 10 that remove the material to be cut during rotation of the drill 10 about the rotation axis A. The first cutting lip 242 faces the first flute 112 and extends from the chisel edge 220 to one of the lands 130. The second cutting lip 244 faces the second flute 114 and extends from the chisel edge 220 to the other of the lands 130. The chisel edge 220 connects the first cutting lip 242 to the second cutting lip 244.

As shown in FIG. 2, the first flute 112 is defined by one of the flank surfaces 232 and the first cutting lip 242; the flank surface 232 extends from a side of the chisel edge 220 along the first side surface 212 of the web 210 and the first cutting lip 242 extends from an opposite side of the chisel edge 220 along the first side surface 212. The second flute 114 is defined by one of the flank surfaces 232 and the second cutting lip 244; the flank surface 232 extends from a side of the chisel edge 220 along the second side surface 214 of the web 210 and the second cutting lip 244 extends from an opposite side of the chisel edge 220 along the second side surface 214.

As shown in FIGS. 1-3, the point 200 has a pair of reliefs 250 extending into the flank surfaces 232. The reliefs 250 are each an area in which a portion of web 210 has been removed.

In the embodiment shown in FIG. 3, the reliefs 250 include a first relief 252 and a second relief 254. The first relief 252 extends into the first side surface 212 of the web 210 in the straight section 234 of one of the flank surfaces 232. The second relief 254 extends into the second side surface 214 of the web 210 in the straight section 234 of the other of the flank surfaces 232. The first relief 252 and the second relief 254 are positioned on opposite sides of the chisel edge 220. In other embodiments, the point 200 may have one relief 250 extending into one of the flank surfaces 232.

Each of the reliefs 250, as shown in FIG. 3, extends into one of the side surfaces 212, 214 of the web 210 and into the upper surface 216 of the web 210. In the shown embodiment, the reliefs 250 do not extend into the chisel edge 220, into either of the cutting lips 240, or into the curved sections 236 of the flank surfaces 232; the reliefs 250 are contained within the straight sections 234 of the flank surfaces 232. In another embodiment, the reliefs 250 could extend into the curved sections 236, but do not extend beyond the curved sections 236.

Each of the reliefs 250, as shown in FIG. 3, extends from a first end 256 to a second end 258 along the radial direction R on one of the side surfaces 212, 214 of the web 210. The first end 256 is positioned adjacent to the chisel edge 220 and is spaced apart from the chisel edge 220. In the shown embodiment, the first end 256 has an angled shape and the second end 258 has a curved shape. In other embodiments, the shapes of the first end 256 and the second end 258 may be different from those in the shown embodiment, depending on the process of creating the relief 250. The reliefs 250 each have a lateral side 260 connecting the first end 256 and the second end 258. The lateral side 260 is parallel to the side surfaces 212, 214 of the web 210 in the shown embodiment. In other embodiments, the lateral side 260 may have other shapes and is not necessarily flat as shown or parallel to the side surfaces 212, 214.

As shown in FIG. 3, each of the reliefs 250 has a first relief depth 262 extending into the web 210 in the radial direction R. The lateral side 260 is positioned at the first relief depth 262 in the radial direction R into the side surface 212, 214 of the web 210. In an embodiment, the first relief depth 262 is up to 75% of the web thickness 218 in the radial direction R. In the shown embodiment, the first relief depth 262 is less than half of the web thickness 218 in the radial direction R. As shown in FIG. 1, each of the reliefs 250 has a second relief depth 264 extending into the upper surface 216 of the web 210 in a direction along the rotation axis A. In the shown embodiment, the second relief depth 264 is approximately equal to the first relief depth 262.

Each of the reliefs 250, as shown in FIG. 3, has a relief length 266 along the side surface 212, 214 of the web 210 in the radial direction R between the first end 256 and the second end 258. In the shown embodiment, the relief length 266 is greater than the chisel edge length 222. The first end 256 of each of the reliefs 250 is spaced apart from the chisel edge 220 by a spacing distance 268 that is less than the relief length 266 and less than the chisel edge length 222. The relief length 266 is 5% to 50% of a drill radius 160 of the drill 10 extending from the chisel edge 220 to one of the lands 130 in the radial direction R, as shown in FIG. 2.

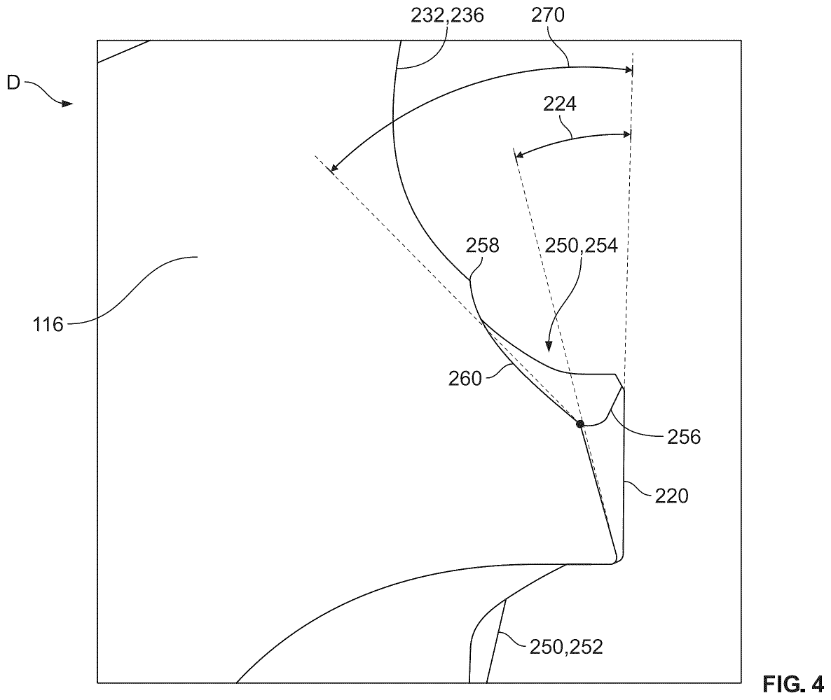

As shown in FIG. 4, each of the reliefs 250 has a relief angle 270 between the lateral side 260 of the relief 250 and the chisel edge 220. The relief angle 270, in an embodiment, can be up to 60°. In another embodiment, the relief angle 270 can be up to 45°. The chisel edge 220 has a chisel angle 224 as shown in FIG. 4; the chisel angle 224 can be 10°to 25°in an embodiment. In an embodiment, the relief angle 270 can be 5°to 25°greater than the chisel angle 224.

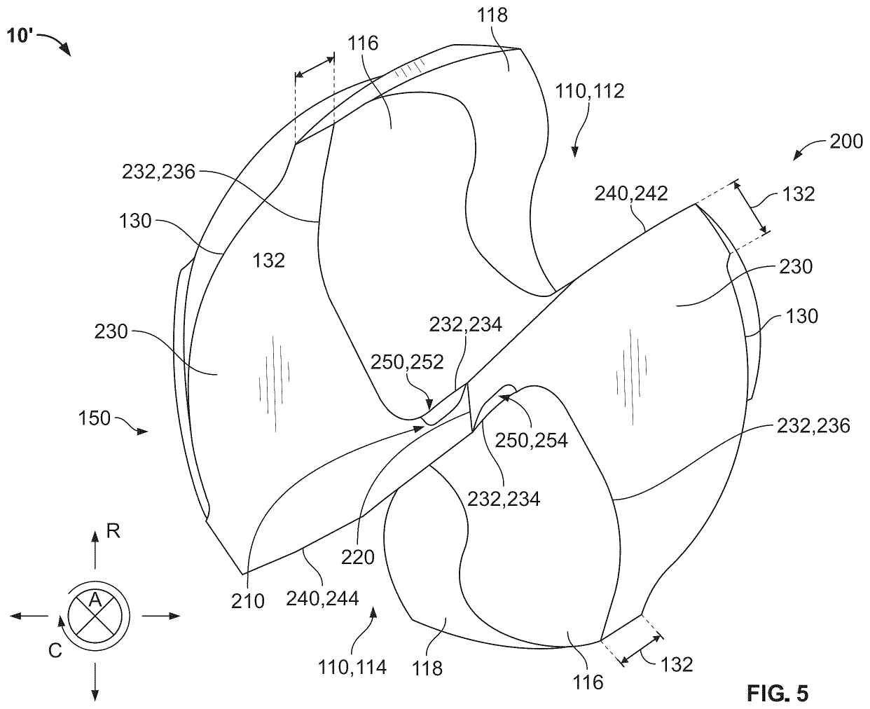

A drill 10′ according to another embodiment is shown in FIG. 5. The drill 10′ is identical to the drill 10 shown in FIGS. 1-4 and described in detail above, except the channels 120 are omitted in the drill 10′; the flanks 230 of the drill 10′ have solid faces and the surfaces of the point 200 of the drill 10′ are not interrupted by the end openings 122 of the channels 120. Otherwise, the web 210, the chisel edge 220, the flanks 230, the cutting lips 240, and the reliefs 250 of the drill 10′ are the same as described above with reference to FIGS. 1-4.

The drills 10, 10′ according to the embodiments described above can be formed from any material commonly used for hole drilling, such as a carbide material. In an embodiment, the body 100 and the point 200 are monolithically formed in a single piece. In another embodiment, the point 200 can be formed separately and attached to the body 100. The reliefs 250, in any embodiment, may be formed by grinding the web 210 to remove material to the specifications of the reliefs 250 described in detail above, such as with a grinding wheel.

During hole cutting, the drill 10, 10′ is rotated about the rotation axis A and the cutting end 150 is moved into contact with the material to be cut. As the drill 10, 10′ penetrates the material, the cutting lips 240 remove the material into chips. The web 210 also contacts the material during rotation about the rotation axis A. Due to the presence of the reliefs 250 in the web 210, the pressure and friction created by engagement of the web 210 with the material is decreased. The reliefs 250 also allow for smoother evacuation of the chips, further decreasing the generated pressure and friction. The presence of the reliefs 250 thus decreases the pressure and temperature without requiring the web 210 to be further thinned, leading to less wear and better longevity without impairing the centering or stability of the drill 10, 10′.

What is claimed is:

1. A drill, comprising:
a body having a plurality of flutes extending along the body; and
a point at a cutting end of the body, the point has a web positioned between the flutes and a chisel edge on the web, the point has a cutting lip and a flank surface defining one of the flutes, the cutting lip extends from the chisel edge and the flank surface extends from a side of the chisel edge opposite the cutting lip, the web has a relief extending into the flank surface.

2. The drill of claim 1, wherein the relief does not extend into the chisel edge or the cutting lip.

3. The drill of claim 1, wherein the relief extends into a side surface of the web facing the one of the flutes and into an upper surface of the web.

4. The drill of claim 1, wherein the relief extends from a first end to a second end along a side surface of the web, the first end is positioned adjacent to the chisel edge and is spaced apart from the chisel edge.

5. The drill of claim 4, wherein the relief has a relief length along the side surface of the web between the first end and the second end, the relief length is greater than a chisel edge length of the chisel edge.

6. The drill of claim 5, wherein the relief length is 5% to 50% of a drill radius of the drill.

7. The drill of claim 5, wherein the first end is spaced apart from the chisel edge by a spacing distance that is less than the relief length and less than the chisel edge length.

8. The drill of claim 4, wherein the relief has a lateral side connecting the first end and the second end, the lateral side is positioned at a first relief depth in a radial direction into the side surface of the web, the first relief depth is up to 75% of a web thickness of the web in the radial direction.

9. The drill of claim 8, wherein the lateral side is flat and parallel to the side surface of the web.

10. The drill of claim 8, wherein the relief has a second relief depth extending into an upper surface of the web along a rotation axis of the drill, the second relief depth is approximately equal to the first relief depth.

11. The drill of claim 8, wherein the relief has a relief angle between the lateral side and the chisel edge that is up to 60°.

12. The drill of claim 1, wherein the flank surface has a straight section and a curved section, the web forms the straight section of the flank surface, the relief is contained within the straight section of the flank surface.

13. The drill of claim 1, wherein the web has a web length along a radial direction that is greater than a chisel edge length of the chisel edge along the radial direction.

14. The drill of claim 1, wherein the plurality of flutes include a first flute and a second flute extending helically along the body.

15. The drill of claim 14, wherein the web has a first side surface facing the first flute and a second side surface facing the second flute, the relief is a first relief extending into the first side surface and the web has a second relief extending into the second side surface.

16. The drill of claim 15, wherein the first relief and the second relief are positioned on opposite sides of the chisel edge.

17. The drill of claim 15, wherein the cutting lip is a first cutting lip defining the first flute with the flank surface, the point has a second cutting lip and another flank surface defining the second flute, the first relief extends into the flank surface and the second relief extends into the another flank surface.

18. The drill of claim 1, wherein the body has a pair of channels extending through the body helically around a rotation axis of the drill.

19. The drill of claim 18, wherein the channels are spaced apart from the web and one of the channels has an end opening extending through the flank surface.

20. The drill of claim 1, wherein the body and the point are monolithically formed in a single piece from a carbide material.
